(19) United States
(12) Patent Application Publication
(10) Pub. No.: US 2020/0172429 A1
(43) Pub. Date: Jun. 4, 2020

(54) CHEMICALLY-ENHANCED ANTI-DAZZLE GLASS AND GLASS FOR ANTI-DAZZLE TREATMENT

(71) Applicant: SICHUAN XUHONG OPTOELECTRONIC TECHNOLOGY CO., LTD., Sichuan (CN)

(72) Inventors: Zaijin LIU, Sichuan (CN); Shiyou WANG, Sichuan (CN); Zhengyi HU, Sichuan (CN); Ruhua GONG, Sichuan (CN)

(73) Assignee: SICHUAN XUHONG OPTOELECTRONIC TECHNOLOGY CO., LTD., Sichuan (CN)

(21) Appl. No.: 16/624,970

(22) PCT Filed: Jun. 22, 2018
(86) PCT No.: PCT/CN2018/092372

§ 371 Date: Dec. 20, 2019

(30) Foreign Application Priority Data
Jun. 29, 2017 (CN) 201710514664.3

(51) Int. Cl. C03C 3/093; C03C 4/18; C03C 3/085; C03C 15/00; C03C 21/00

(52) U.S. Cl. CPC C03C 3/093; C03C 4/18; C03C 2204/00; C03C 15/00; C03C 21/002; C03C 3/085

(57) ABSTRACT

Provided is a chemically-enhanced anti-dazzle glass. The glass comprises the following oxides based on mole percentage: 58% to 64%, preferably 62% to 64% of SiO_{2;} 5% to 8.5%, preferably 6.2% to 8.5% of Al₂O_{3;} 10% to 14%, preferably 12.5% to 14% of Na₂O; 3% to 5% of K₂O; and 8% to 11% of MgO; wherein at least one surface of the glass is subjected to anti-dazzle treatment. Also provided are glass for anti-dazzle treatment and the anti-dazzle glass prepared therefrom.

### FIELD OF THE INVENTION

The present invention relates to a chemically-enhanced anti-dazzle glass. The invention also relates to a glass for anti-dazzle treatment. The glass or anti-dazzle glass provided herein may be used as cover glass of various flat panel displays such as mobile phones, computers, car navigators, or other products with high requirements for anti-dazzle performance.

### BACKGROUND OF THE INVENTION

With the development of visual glass materials, the influence of light and sunlight in daily life and working environment is becoming more and more obvious, thus the anti-dazzle technology for glass and its application are particularly important. At present, the anti-dazzle technology for glass has matured.

The preparation process of anti-dazzle glass is mainly divided into mechanical method and chemical method. Mechanical processing methods mainly include sandblasting, grinding, and blowing method, while chemical processing methods mainly involve chemical etching and surface coating. Among them, the most commonly used process in the industry is chemical etching due to its advantages of simple process, easy control, and suitable for large-area preparation. However, the strength property of an anti-dazzle glass thus prepared is not so satisfying even after undergoing an enhancing process.

Therefore, there is a need to provide an anti-dazzle glass with satisfying strength properties such as bending resistance, dropping resistance, hardness, and scratching resistance.

### CONTENTS OF THE INVENTION

Accordingly, in one aspect the present invention provides a chemically-enhanced anti-dazzle glass, wherein the glass comprises the following oxides based on mole percentage:

58% to 64%, preferably 62% to 64% of SiO₂;

5% to 8.5%, preferably 6.2% to 8.5% of Al₂O₃;

10% to 14%, preferably 12.5% to 14% of Na₂O;

3% to 5% of K₂O; and

8% to 11% of MgO.

The anti-dazzle glass according to the first aspect may further comprise the following oxides based on mole percentage:

0% to 2% of ZrO₂;

0% to 1% of B₂O₃;

0% to 1% of ZnO;

0% to 1% of Li₂O.

In the first aspect, at least one surface of the glass may be subjected to an anti-dazzle treatment.

The anti-dazzle glass according to the present invention, the two surfaces of the glass may also be subjected to an anti-dazzle treatment.

In an advantageous circumstance, the chemically-enhanced anti-dazzle glass provided herein comprises the following oxides based on mole percentage or consists of the following oxides based on mole percentage:

58% to 64%, preferably 62% to 64%, further preferably 62.80%, 63.57%, 63.73%, or 63.93% of SiO₂;

5% to 8.5%, preferably 6.2% to 8.5%, further preferably 6.45%, 7.22%, 8.06%, 8.12%, or 8.47% of Al₂O₃;

10% to 14%, preferably 12.5% to 14%, further preferably 12.62%, 12.87%, 13.07%, 13.32%, or 13.61% of Na₂O;

3% to 5%, further preferably 3.23%, 3.80%, 3.95%, 4.02% of K₂O;

8% to 11%, further preferably 8.77%, 10.52%, 10.68%, 10.86% of MgO;

0% to 2%, preferably 1.25% to 1.90% of ZrO₂;

0% to 1%, preferably 0.10% to 0.75% of B₂O₃;

0% to 1%, preferably 0.10% to 0.45% of ZnO; and

0% to 1%, preferably 0.50% to 0.75% of Li₂O.

In the anti-dazzle glass provided herein, the surface subjected to the anti-dazzle treatment is rough, and the roughness is from 10 μm to 60 μm. The anti-dazzle glass may have a haze of 3% to 7%. Preferably, the measured 60° glossiness of the anti-dazzle glass may be from 100 to 110 GU.

The anti-dazzle glass is preferably subjected to a chemical enhancement treatment. In the chemical enhancement process, the glass is immersed in the KNO₃ enhancing liquid to cause ion exchange between the KNO₃ enhancing liquid and the glass. Preferably, the N⁺ ion concentration in the KNO₃ enhancing liquid is less than 10,000 ppm

The anti-dazzle glass according to the present invention may have the following properties after chemical enhancement: a surface compressive stress of CS ≥650 MPa, preferably≥700 MPa; and/or a stress layer depth of DOL≥30 μm, preferably≥35 μm; and/or pencil hardness (H)>9; and/or four-point bending strength≥500 MPa, preferably≥600 MPa, more preferably≥700 MPa.

The anti-dazzle glass according to the present invention is generally a glass plate, and may have a thickness of 0.2 mm to 3 mm.

In a second aspect, the present invention provides a glass for anti-dazzle treatment, wherein the glass for anti-dazzle treatment comprises the following oxides based on mole percentage:

58% to 64%, preferably 62% to 64%, further preferably 62.80%, 63.57%, 63.73%, or 63.93% of SiO₂;

5% to 8.5%, preferably 6.2% to 8.5%, further preferably 6.45%, 7.22%, 8.06%, 8.12%, or 8.47% of Al₂O₃;

10% to 14%, preferably 12.5% to 14%, further preferably 12.62%, 12.87%, 13.07%, 13.32%, or 13.61% of Na₂O;

3% to 5%, further preferably 3.23%, 3.80%, 3.95%, 4.02% of K₂O;

8% to 11%, further preferably 8.77%, 10.52%, 10.68%, 10.86% of MgO.

The glass according to the second aspect may further comprise the following oxides based on mole percentage:

0% to 2%, preferably 1.25% to 1.90% of ZrO₂;

0% to 1%, preferably 0.10% to 0.75% of B₂O₃;

0% to 1%, preferably 0.10% to 0.45% of ZnO; and

0% to 1%, preferably 0.50% to 0.75% of Li₂O.

Therefore, in still another aspect, the invention provides an anti-dazzle glass obtained by subjecting at least one surface of the above glass for anti-dazzle treatment to an anti-dazzle treatment.

Particularly, the anti-dazzle treatment may be chemical etching.

After an anti-dazzle treatment, the above anti-dazzle treatment glass has a surface roughness of 10 μm to 60 μm, a haze of 3% to 7%, and a 60° glossiness of 100 to 110 GU.

### DETAILED DESCRIPTION OF EMBODIMENTS

As described above, the present invention is intended to provide a glass having satisfactory strength properties and anti-dazzle effects, particularly an anti-dazzle glass prepared by chemical etching. That is to say, the glass (plate) provided herein may have an unimpaired anti-dazzle effect while having excellent strength properties after undergoing a conventional chemical enhancement process.

Surprisingly, the inventors of the present invention found that such a glass (original sheet) can be provided by optimizing the glass raw material. Such an original glass sheet can provide a finished glass product having excellent strength properties (for example, dropping resistance, bending resistance, high hardness, etc.) and anti-dazzle effects after undergoing anti-dazzle treatment and chemical enhancement.

Accordingly, the present invention firstly provides a glass composition as a basis, whereby a glass provided herein comprises the following oxides based on mole percentage:

58% to 64% of SiO₂;

5% to 8.5% of Al₂O₃;

10% to 14% of Na₂O;

3% to 5% of K₂O; and

8% to 11% of MgO.

Preferably, the glass may further comprise the following oxides based on mole percentage:

0%-2% of ZrO₂;

0%-1% of B₂O₃;

0%-1% of ZnO; and

0%-1% of Li₂O.

In a preferred embodiment, the glass according to the invention comprises 62% to 64% of SiO₂ based on mole percentage.

In a preferred embodiment, the glass according to the invention comprises 6.2% to 8.5% of Al₂O₃ based on mole percentage.

In a preferred embodiment, the glass according to the invention comprises 12.5% to 14% of Na₂O based on mole percentage.

In particularly preferred embodiments, the glass according to the invention consists of the ingredients mentioned above.

The glass according to the present invention can be prepared from the provided glass composition by a conventional glass manufacturing method in the art. The conventional glass manufacturing method includes, but is not limited to, a float method or an overflow method.

The present invention also provides an anti-dazzle glass based on the prepared glass. The anti-dazzle glass comprises the following oxides based on mole percentage:

58% to 64% of SiO₂;

5% to 8.5% of Al₂O₃;

10% to 14% of Na₂O;

3% to 5% of K₂O; and

8% to 11% of MgO.

Wherein, at least one surface of the glass is subjected to an anti-dazzle treatment. The anti-dazzle treatment can be performed on both surfaces of the anti-dazzle glass depending on the actual requirements of the anti-dazzle effects and application scenarios.

Preferably, the anti-dazzle glass may further comprise the following oxides based on mole percentage:

0%-2% of ZrO₂;

0%-1% of B₂O₃;

0%-1% of ZnO;

0%-1% of Li₂O.

In a preferred embodiment, the anti-dazzle glass according to the invention comprises 62% to 64% of SiO₂ based on mole percentage.

In a preferred embodiment, the anti-dazzle glass according to the invention comprises 6.2% to 8.5% of Al₂O₃ based on mole percentage.

In a preferred embodiment, the anti-dazzle glass according to the invention comprises 12.5% to 14% of Na₂O based on mole percentage.

In particularly preferred embodiments, the anti-dazzle glass according to the invention consists of the ingredients mentioned above.

In the present context, the “anti-dazzle treatment” of the glass means that at least one surface of the glass is specially treated to reduce the reflectivity of the glass to light, thereby reducing the interference of ambient light and reducing the reflection of the screen, so that the image is more clear. In the present specification, “anti-dazzle treatment” may in principle include mechanical treatment and chemical treatment. In an advantageous circumstance, the anti-dazzle treatment herein uses a chemical etching method.

As for the glass according to the present invention, the surface subjected to the anti-dazzle treatment is rough, and the roughness is from 10 μm to 60 μm. Preferably, the haze is from 3% to 7%, and/or the 60° glossiness is from 100 to 110 GU. The inventors of the present invention found that such an anti-dazzle effect is particularly suitable for a cover glass for various flat panel displays.

As used herein, “60° glossiness” means the gloss measurement when light is incident on the sample at an angle of 60 degrees to the normal of the glass surface. The unit of glossiness is GU, i.e., the gloss unit.

As used herein, “haze” is the percentage of transmitted light intensity above the angle of 2.5° from the incident light compared to the total transmitted light intensity.

Of course, it can be understood that strength properties of the glass or the anti-dazzle treated glass according to the present invention can be improved in the post-treatment process by various conventional methods for enhancing the glass in the field. The methods include, but are not limited to physical tempering, chemical enhancement, polishing and grinding, and the like. In the processing of the glass according to the present invention, chemical enhancement is preferably employed as a later enhancing mode.

As used herein, “chemical enhancement” should be understood to mean enhancing a glass by an ion exchange method known to those skilled in the glass manufacturing field. Such ion exchange methods include, but are not limited to, the treatment of hot alkali aluminosilicate glass (or other suitable alkali-containing glass) with hot melted liquid, wherein the hot melted liquid contains ions with an ionic radius greater than that present in the surface of the glass, thereby replacing smaller ions with larger ions. For example, potassium ions can replace sodium or lithium ions in the glass. Or other alkali metal ions with a larger atomic radius, such as rubidium or cesium, may replace smaller alkali metal ions such as potassium in the glass. Similarly, other alkali metal salts including, but not limited to sulfates, halides, and the like can be used in the ion exchange process. For example, the glass plate can be immersed in a potassium nitrate melted liquid at 390 to 450 ° C. for 3-6 hours or more, thereby completing the chemical enhancement. Preferably, the concentration of Na ions in the potassium nitrate melted liquid is less than 10,000 ppm.

Surprisingly, the inventors of the present invention found that after undergoing the chemical enhancement, the anti-dazzle glass provided herein is not only excellent in anti-dazzle effect but also has greatly improved strength properties. In an advantageous circumstance, the chemically-enhanced anti-dazzle glass has a surface compressive stress of CS≥650 MPa, preferably≥700 MPa; a stress layer depth of DOL≥30 μm, preferably≥35 μm; a pencil hardness (H)>9, and a four-point bending strength≥500 MPa, preferably≥600 MPa, and more preferably ≥700 MPa. Such mechanical properties also make the chemically-enhanced anti-dazzle glass provided herein more suitable for use as a cover glass for various flat panel displays.

Only as an illustrative example, the chemically-enhanced anti-dazzle glass according to the present invention may be prepared as follows:

1. Providing glass ingredients according to the composition provided.

2. An original glass sheet is obtained according to the following process: batching→melting→forming→annealing→cutting, ensuring that the surface of the glass is free from scratches, pits, bubbles and other defects. The point defects on the glass surface will affect the strength properties of the glass; wherein the thickness of the glass may be 0.2 mm to 3 mm.

3. An original glass sheet is made into the required sizes by the processing operations of computer numerical control (CNC) machine tools, ensuring that the edge breaking size for edge of the glass is less than 30 μm after edge grinding, and the edge processing quality will affect the strength properties of the glass.

4. The glass sheets (glass samples) are soaked in an etching liquid (for example, a mixed solution of NH₄HF₂ and 10% propylene glycol) to make the surface of the glass rough, then taking out to rinse them. In this step, both sides of the glass may be chemically etched. It is also possible to apply a film to one side of the glass as needed, and only the other side is chemically etched.

5. The glass samples are then soaked in an acid solution (e.g., H₂SO₄), keeping the samples vertical so that the fluid passes over the surface. While immersing the glass samples in the acid solution bath, mechanical agitation is carried out by vertical movement.

6. The glass samples are washed again with deionized water, and then immersed and polished in a mixed solution containing HF and HCl. The samples are stirred in a bath of the mixed solution containing HF and HCl by using the same stirring method in the above acid solution bath.

7. Finally, the glass samples are taken out and rinsed with deionized water, then drying with a stream of nitrogen.

8. The washed and dried glass samples are then chemically-enhanced, and the Na⁺ ion concentration in the KNO₃ melted liquid is less than 10,000 ppm. If the Na⁺ ion concentration is too high, it will affect the glass properties after chemical enhancement.

Thus, a chemically-enhanced anti-dazzle glass according to the present invention is obtained.

As compared with the prior art, on the basis of the chemically-enhanced anti-dazzle glass provided herein, a glass plate with stronger strength properties after chemical enhancement is obtained, in addition to excellent anti-dazzle property, the properties including bending resistance, dropping resistance, hardness, and scratching resistance of said glass are superior to those of the anti-dazzle glass on the market.

Therefore, the glass provided herein is particularly suitable for use as an anti-dazzle glass plate of a display device. For example, the glass (plate) provided herein may be used as cover glass in a series of flat panel displays such as mobile phones, computers, car navigators, etc., or other occasions where high strength performance is required.

### EXAMPLES

The embodiments of the present invention are described in detail below. It should be understood that the specific embodiments described herein are merely illustrative of the invention and are not intended to limit the invention.

First, a glass plate is prepared. The glass plates of the present invention with different contents of the ingredients are prepared according to the proportions of the ingredients in Examples 1 to 10 in Table 1. Five comparative examples of glass are also given in the following table, i.e., Comparative Examples 1 to 5. The data in the following table is given on the basis of mole percentage of the oxides.

TABLE 1

| Number | SiO₂ | Al₂O₃ | Na₂O | K₂O | MgO | ZrO₂ | B₂O₃ | ZnO | Li₂O |
|---|---|---|---|---|---|---|---|---|---|
| Example 1 | 63.75 | 8.50 | 13.10 | 3.80 | 10.45 | 0.40 | 0.00 | 0.00 | 0.00 |
| Example 2 | 64.00 | 6.45 | 14.00 | 3.00 | 11.00 | 0.10 | 0.00 | 1.00 | 0.45 |
| Example 3 | 58.00 | 8.50 | 14.00 | 5.00 | 11.00 | 2.00 | 1.00 | 0.50 | 0.00 |
| Example 4 | 64.00 | 8.00 | 10.00 | 4.40 | 10.00 | 1.00 | 0.80 | 0.80 | 1.00 |
| Example 5 | 63.50 | 5.00 | 13.30 | 4.00 | 10.60 | 1.20 | 1.00 | 0.60 | 0.80 |
| Example 6 | 64.00 | 7.20 | 12.80 | 5.00 | 8.00 | 0.60 | 0.75 | 0.70 | 0.95 |
| Example 7 | 62.80 | 8.10 | 13.60 | 4.80 | 10.30 | 0.00 | 0.00 | 0.00 | 0.40 |
| Example 8 | 63.73 | 8.47 | 13.07 | 3.8 | 10.52 | 1.30 | 0.70 | 0.15 | 0.75 |
| Example 9 | 63.93 | 8.06 | 12.62 | 4.01 | 10.86 | 1.85 | 0.20 | 0.45 | 0.50 |
| Example 10 | 63.88 | 8.32 | 12.90 | 3.95 | 10.68 | 1.55 | 0.48 | 0.37 | 0.66 |
| Comparative | 64.60 | 6.40 | 15.00 | 5.00 | 6.60 | 1.20 | 0.60 | 0.40 | 0.20 |
| Example 1 | | | | | | | | | |
| Comparative | 57.50 | 4.50 | 16.00 | 9.00 | 13.00 | 0.00 | 0.00 | 0.00 | 0.00 |
| Example 2 | | | | | | | | | |
| Comparative | 64.20 | 8.30 | 9.50 | 2.20 | 10.00 | 2.20 | 1.30 | 1.10 | 1.20 |
| Example 3 | | | | | | | | | |
| Comparative | 67.20 | 2.30 | 13.00 | 1.70 | 11.00 | 1.20 | 1.00 | 1.00 | 1.60 |
| Example 4 | | | | | | | | | |
| Comparative | 60.00 | 7.00 | 12.00 | 4.60 | 13.00 | 1.00 | 1.30 | 1.10 | 0.00 |
| Example 5 | | | | | | | | | |

The specific preparation process of the glass plate provided herein is as follows:

According to the proportions of the ingredients in Table 1 above, the mixed raw materials are put into sealed bags respectively, mixing in the sealed bags, then pouring into platinum crucibles to melt, and the molten glass liquids are poured into metal molds. The glass together with the metal molds are placed in annealing furnace for precision annealing and cooling, and finally the glass plates having a thickness of 0.70 mm are formed respectively.

The glass plates are made into 50 mm×50 mm×0.70 mm glass samples by CNC, and 20 glass samples are prepared for each of the Examples and Comparative Examples. Then check the edge with a microscope to ensure that the edge breaking size is not more than 30 μm.

The glass sheets (glass samples) passing the edge inspection are immersed in a static solution containing 6% of NH₄HF₂ and 10% of propylene glycol by weight for 5 minutes, i.e., the anti-dazzle treatment is performed on both sides. Then the glass samples are rinsed with deionized (DI) water for 1 minute.

They are then soaked in 1 M H₂SO₄ for 5 minutes, during which time the glass samples remain vertical to allow fluid to pass over the surface, and mechanical agitation is conduct by vertical motion while the glass samples are immersed in the H₂SO₄ bath. The agitation speed is approximately 2 Hz, and the traveling distance is approximately 2 inches.

The glass samples are then rinsed again with deionized water for 1 minute, and soaked for 10 minutes in a solution containing 4% HF+4% of HC1 by weight. The glass samples are stirred in a HF+HCl bath by using the same agitation method in the H₂SO₄ bath.

The glass samples are taken out and rinsed with deionized water, and then dried with a stream of nitrogen. The dried glass samples are chemically-enhanced in a KNO₃ enhancing solution (with a Na⁺ concentration of about 3000 ppm) at 400° C. for about 4 hours.

Then glass samples are taken out, test its strength properties including surface compressive stress (CS), stress layer depth (DOL), pencil hardness (H), four-point bending performance (4PB), as well as 60° glossiness, haze, and roughness performance. The average values of the test results of 20 glass sheets for each sample are shown in Table 2:

TABLE 2

| | | Test Items | | | | | | |
|---|---|---|---|---|---|---|---|---|
| | | | | Pencil | | 60° | | |
| | | CS | DOL | Hardness | 4PB | Glossiness | Haze | Roughness |
| | | (MPA) | (μm) | (H) | (Mpa) | (GU) | (%) | (μm) |
| | | Test Instrument Model | | | | | | |
| | | | | Pencil | Universal | Glossiness | Haze | |
| | | Surface Stress | | Hardness | Testing | Meter | Meter | Roughness |
| | | Tester | | Tester | Machine | BYK- | BYK- | Tester |
| | | FGSM-6000LE | | B-3084 | QJ-211S | 4446-60 | 4775 | 1400D-12 |
| Test | Example 1 | 750 | 38 | >9 | 730 | 110 | 6.21 | 24 |
| Results | Example 2 | 726 | 36 | >9 | 744 | 109 | 6.22 | 26 |
| | Example 3 | 784 | 38 | >9 | 751 | 110 | 6.21 | 25 |
| | Example 4 | 770 | 37 | >9 | 746 | 110 | 6.24 | 24 |
| | Example 5 | 686 | 40 | >9 | 751 | 110 | 6.24 | 27 |
| | Example 6 | 715 | 39 | >9 | 730 | 110 | 6.22 | 24 |
| | Example 7 | 791 | 41 | >9 | 729 | 108 | 6.24 | 28 |
| | Example 8 | 796 | 45 | >9 | 764 | 110 | 6.25 | 28 |
| | Example 9 | 798 | 46 | >9 | 770 | 110 | 6.24 | 27 |
| | Example 10 | 795 | 43 | >9 | 762 | 110 | 6.25 | 28 |
| | Comparative | 463 | 28 | >9 | 440 | 109 | 6.23 | 24 |
| | Example 1 | | | | | | | |
| | Comparative | 510 | 24 | 8 | 451 | 112 | 6.24 | 26 |
| | Example 2 | | | | | | | |
| | Comparative | 482 | 27 | >9 | 461 | 111 | 6.25 | 25 |
| | Example 3 | | | | | | | |
| | Comparative | 455 | 27 | 8 | 462 | 111 | 6.21 | 24 |
| | Example 4 | | | | | | | |
| | Comparative | 489 | 26 | >9 | 425 | 110 | 6.22 | 23 |
| | Example 5 | | | | | | | |

As can be clearly seen from the above Table 2, various strength properties of the glass sheets of the respective ingredients shown in Examples 1-10 according to the present invention are obviously superior to those of the glass sheets in Comparative Examples 1-5, although the anti-dazzle properties are comparable to those of the glass sheets in Comparative Examples 1-5.

The above Examples are merely preferred examples of the present invention, and are not intended to limit the scope of the present invention. Any changes made without creative work on the basis of the design principles of the present invention will fall into the protection scope of the present invention.

1. A chemically-enhanced anti-dazzle glass, wherein the glass comprises the following oxides based on mole percentage:
58% to 64%, preferably 62% to 64% of SiO₂;
5% to 8.5%, preferably 6.2% to 8.5% of Al₂O₃;
10% to 14%, preferably 12.5% to 14% of Na₂O;
3% to 5% of K₂O; and
8% to 11% of MgO;
wherein at least one surface of the glass is subjected to an anti-dazzle treatment.

2. The anti-dazzle glass according to claim 1, wherein the glass further comprises the following oxides based on mole percentage:
0% to 2% of Zr₂O;
0% to 1% of B₂O₃;
0% to 1% of ZnO;
0% to 1% of Li₂O.

3. The anti-dazzle glass according to claim 1, wherein the surface subjected to the anti-dazzle treatment has a roughness of 10 μm to 60 μm, a haze of 3% to 7%, and a 60° glossiness of 100 to 110 GU.

4. The anti-dazzle glass according to claim 1, wherein the chemical enhancement comprises soaking the glass with a KNO₃ enhancing liquid, and the Na⁺ ion concentration in the KNO₃ melt liquid is less than 10,000 ppm.

5. The anti-dazzle glass according to claim 1, wherein the anti-dazzle glass has a surface compressive stress of CS≥650 MPa, preferably≥700 MPa; a stress layer depth of DOL≥30 μm, preferably≥35 μm; a pencil hardness (H)>9; and a four-point bending strength≥500 MPa, preferably≥600 MPa, and more preferably≥700 MPa.

6. The anti-dazzle glass according to claim 1, which has a thickness of 0.2 mm to 3 mm.

7. A glass for anti-dazzle treatment, wherein the glass for anti-dazzle treatment comprises the following oxides based on mole percentage:
58% to 64%, preferably 62% to 64% of SiO₂;
5% to 8.5%, preferably 6.2% to 8.5% of Al₂O₃;
10% to 14%, preferably 12.5% to 14% of Na₂O;
3% to 5% of K₂₀; and
8% to 11% of MgO.

8. The glass for anti-dazzle treatment according to claim 7, wherein the anti-dazzle treatment glass further comprises the following oxides based on mole percentage:
0% to 2% of ZrO₂;
0% to 1% of B₂O₃;
0% to 1% of ZnO;
0% to 1% of Li₂O.

9. An anti-dazzle glass obtained by subjecting at least one surface of the glass for anti-dazzle treatment according to claim 7 to an anti-dazzle treatment, preferably chemical etching.

10. The anti-dazzle glass according to claim 9, wherein the surface subjected to the anti-dazzle treatment has a roughness of 10 μm to 60 μm, a haze of 3% to 7%, and a 60° glossiness of 100 to 110 GU.
